(19) United States
(12) Patent Application Publication
(10) Pub. No.: US 2004/0123424 A1
(43) Pub. Date: Jul. 1, 2004

(54) Pivotal shaft assembly

(75) Inventor: I-Hsiang Chiu, Taoyuan City (TW)

Correspondence Address: BRUCE H. TROXELL, SUITE 1404, 5205 LEESBURG PIKE, FALLS CHURCH, VA, 22041, US

(73) Assignee: Nan Juen International Co., Ltd.

(21) Appl. No.: 10/384,560

(22) Filed: Mar. 11, 2003

(30) Foreign Application Priority Data
Dec. 25, 2002 (TW) 091221108

(51) Int. Cl. E05D 1/00

(52) U.S. Cl. 16/221

(57) ABSTRACT

A pivotal shaft assembly includes a stationary part, a movable part, an joint part, a relay part, a connection part and an extension part. Once the stationary part and the movable part are fixedly attached to an open end of a stationary object and the inner side of a movable object respectively, the extension stem stretches to an extreme length during the relay part and the extension part being axially aligned as a line so as to form a standstill point. If an foreign force is exerted, the extension stem is drawn inward to allow the relay, the connection part and the movable part generating upward or downward relative motions to each other such that the movable object can open or shut the open end of the stationary object automatically.

### BACKGROUND OF THE INVENTION

1. Field of the Invention

The present invention relates to a pivotal shaft assembly and particularly to a pivotal shaft assembly with a function of automatically lifting and descending gradually.

2. Description of Related Art

It is known that the furniture is indispensable appliance in our daily life. Especially, a cabinet or drawers in a chest play an important role for taking up articles. A drawer is actuated by way of the drawer box at both lateral sides thereof is joined a slide rail respectively and the hollow space in the chest for the drawer is provided with a slide rail at two opposite lateral sides thereof respectively. Thus, the drawer can be pushed into the hollow space for articles being taken up and can be pulled out of the hollow space for the articles being picked up. This is a usual way get used to us. The cabinet usually has an open end with a door and a pivotal shaft device such as a hinge device is provided between the open end and the door so that the door can be opened or shut for taking out or receiving articles.

Accordingly, the importance of the pivotal shaft is not less than the slide rail. Further, in order to assure the door and the cabinet being capable of close contact with each other, the pivotal shaft at another end thereof can be provided with a lock between the door and the cabinet or with a magnet for joining the door and the cabinet by way of magnetic attraction. Besides, the pivotal shaft at the stationary part thereof can be attached with a hydraulic cylinder and the plunger of the hydraulic cylinder can be connected to the movable part, which pivotally joins the stationary part, such that the door can stay at any angular position during the plunger stretching and drawing back. The deficiency of preceding pivotal shaft is in that no function with regard to automatic open and shut, that is, the door is often shut incompletely and a quite large clearance is left in case of the weight of the door being less than the exerting force so that the user has to exert an extra force before the door being able to shut the cabinet.

### SUMMARY OF THE INVENTION

A primary object of the present invention is to provide a pivotal shaft assembly, which is composed of a stationary part, a movable part, a relay part, a connecting part and an extension part, with the stationary part and the movable part being fixed to an open end of a stationary object and a movable part at the inner side thereof respectively such that the movable object can be opened from and shut to the stationary object with a function of automatically lifting and descending gradually.

Another object of the present invention is to provide a pivotal shaft assembly with which the movable object descending gradually is performed with the aid of the pulling force of an extension part instead of the weight of the movable object so that the movable object is not limited to be made of heavy board.

A further object of the present invention is to provide a pivotal shaft assembly with which the relative movements between the extension part, the relay part, the connecting part and the movable part allow the movable object tightly shutting the open end of the stationary object without a clearance.

A further object of the present invention is to provide a pivotal shaft assembly with which a sufficient shut force can be obtained in spite of a joining device such as a lock or a magnetic attraction object being not mounted between the movable and the stationary objects.

### BRIEF DESCRIPTION OF THE DRAWINGS

The present invention can be more fully understood by reference to the following description and accompanying drawings, in which:

FIG. 1 is a perspective view illustrating a pivotal shaft assembly according to the present invention being attached to a cabinet;

FIG. 2 is an exploded perspective view of the pivotal shaft assembly shown in FIG. 1;

FIG. 3 is an assembled perspective view of the pivotal shaft assembly shown in FIG. 2; and

FIG. 4a is side view of the pivotal shaft assembly according to the present invention illustrating being in a state of shut;

FIG. 4b is a side view similar to FIG. 4a illustrating the pivotal shaft assembly in a state of stopping; and

FIG. 4c is another side view similar to FIG. 4a illustrating the pivotal shaft assembly in a state of opening.

### DETAILED DESCRIPTION OF THE PREFERRED EMBODIMENT

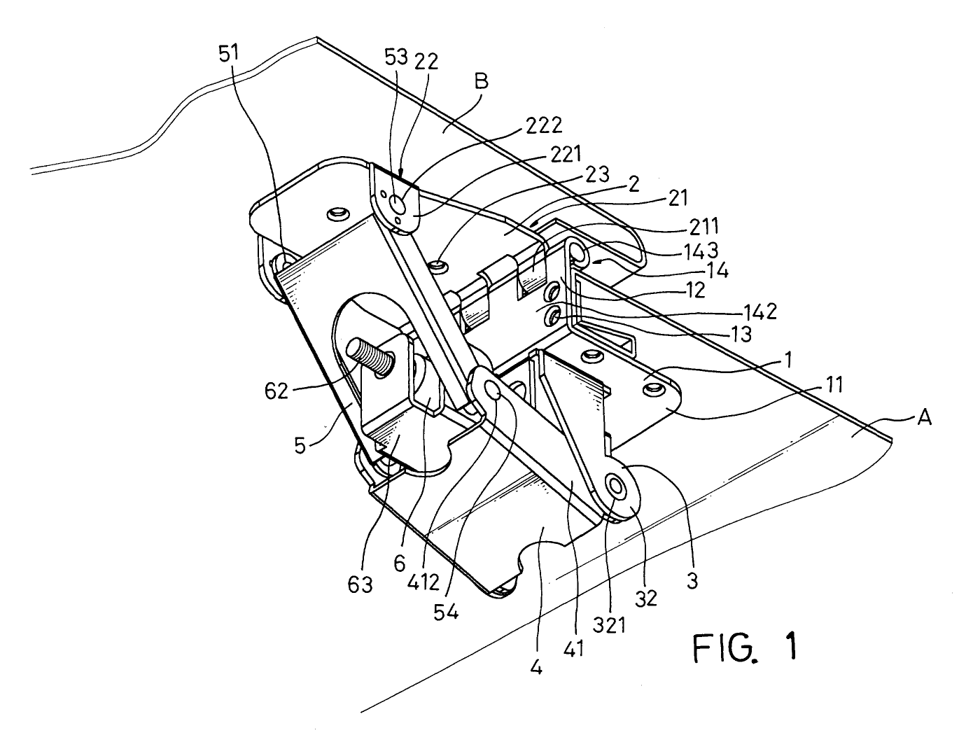

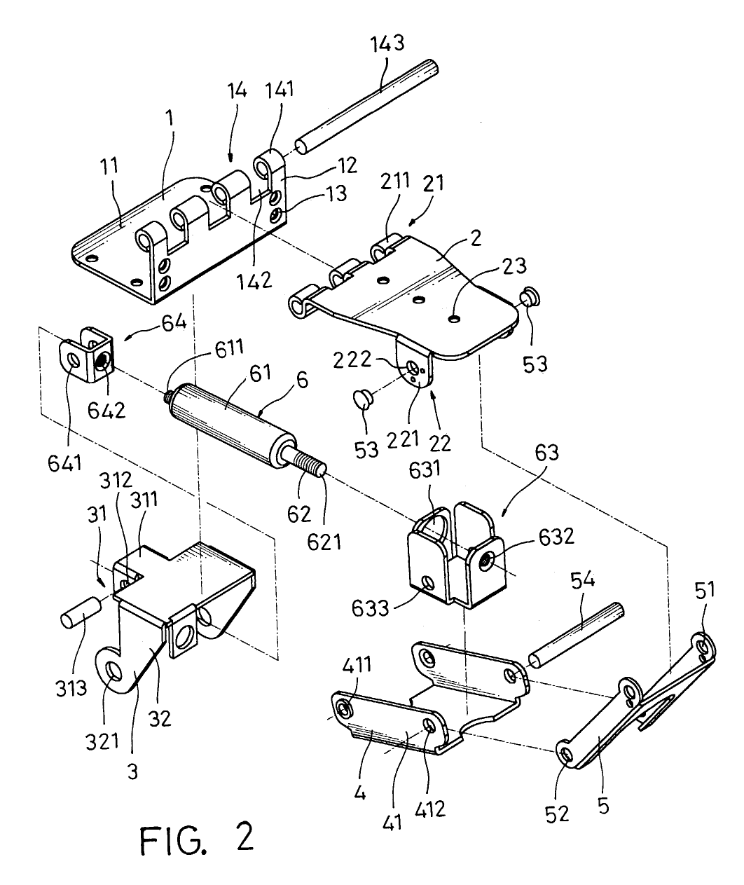

Referring to FIGS. 1 to 3, a pivotal shaft assembly according to the present invention basically includes a stationary part 1, a movable part 2, a joint part 3, a relay part 4, a connecting part 5 and an extension part 6.

Wherein, the stationary part 1 is frame such as a L shaped frame and is provided with frame holes 13 at the horizontal frame section 11 and the vertical frame section 12 thereof so as to be fastened to a stationary object A such as an open end of a cabinet by way of conventional fastening way such as being passed through with screws. Of course, the fastening way can be done with rivets or welding except by way of screw fastening so that these fastening ways are included within the scope of the present invention. Besides, the vertical section 12 at the upper edge thereof is provided with an axial join part 14 so as to join with the movable part 2 pivotally. The axial join part 14 has an annual section 141 with at least a recess 142 to correspond to and accommodate at least an annular section 211. Once a shaft pin 143 passes through the annular sections 141, 211, an effect of pivotal connection can be obtained.

The movable part 2 is a flat plate with an axial connection end 21, 22 at both ends thereof respectively. The inner axial connection end 21 has at least the annular section 211 for being pivotally joined to the stationary part 1 as the preceding description and the outer axial connection end 22 has two opposite tabs 221 with an axial hole 222 therein for connecting with the connecting part 5 pivotally so as to constitute a movement linkage. Wherein, the movable part 2 has at least a plate hole 23 so as to be fastened to a movable object B such as a door by means of the conventional way such as screws. Of course, fastening ways such as rivets or welding can be used and the same effect of movement linkage can be obtained advantageously.

The joint part 3 is a frame and is fixedly attached to the stationary part 1 at the lower side thereof by way of such as spot welding. The joint part 3 at an end thereof has a connecting end 31 for being joined to the extension part 6 and it can be seen that the connecting end 31 is an inversed U shaped fitting piece with a fitting hole 312 at two opposite lateral walls thereof for being inserted with insert section 64. Next, a pin shaft 313 is arranged to pass through the fitting hole 312 and central holes 641 to form pivotal connection. Besides, the joint part 3 at both lateral sides thereof extends downward a side plate 32 respectively with a side hole 321 in each side plate 32 so as to connect with the relay part 4 pivotally.

The relay part 4 is a frame body and the rear end thereof connects with the side plates 32 by way of two wing plates 41 at the rear ends thereof having a protruding ring 411 respectively so as to be inserted into the side holes 321 as an engagement. The wing plates 41 at the respective front end thereof have a connecting hole 412 for joining with connection part 5 and the extension part 6 pivotally.

The connection part 5 is a frame with an end thereof having fastening holes 51 corresponding to the axial holes 222 and the other end thereof having projection holes 52 corresponding to the connecting holes 412. Thus, the connection part 5 can be joined to the movable part 2 by way of short pin shaft 53 passing through the axial holes 222 and fastening holes 51 and can be joined to the relay part 4 by way of a pin shaft 54 passing through the connecting holes 412 and the projection holes 52. In this way, the connection part 5 can be disposed between the movable part 2 and the relay part 4 in a rotational state.

The extension part 6 has a rod body 61 with an extension stem 62 and the extension stem 62 at the front end thereof is a stem end 621. The rod body 61 and the extension stem 62 with the stem end 621 thereof are received in a support hole 631 and a locating hole 632 at both ends of a follower 63 respectively. It can be seen that the stem end 621 and the locating hole 632 are provided with screw threads for engaging with each other. It is noted that the preceding threaded fastening is only an example and not a limitation. The follower 63 at both lateral sides thereof has piercing holes 633 for being passed through with the pin shaft 54 such that the relay part 4, the connection part 5 and the movable part 2 can generate relative motions to each other due to the extension stem 62 stretching and withdrawing. The principle with regard to the relative motions will be explained afterward. The rod body 61 at the rear end thereof is provided with a joining end 611 to connect with a joining hole 642 of the insert piece 64 by way of, for instance, the joining end 611 and the joining hole having screw threads. But, it is noted that joining with screw threads is an example only and not a limitation. Besides, the extension part 6 preferably is an inward pull spring rod, a hydraulic plunger or a pneumatic plunger while in use so that the extension stem 62 can stretch or withdraw automatically with the aid of the elastic force so as to generate the desired effect of lifting and descending gradually.

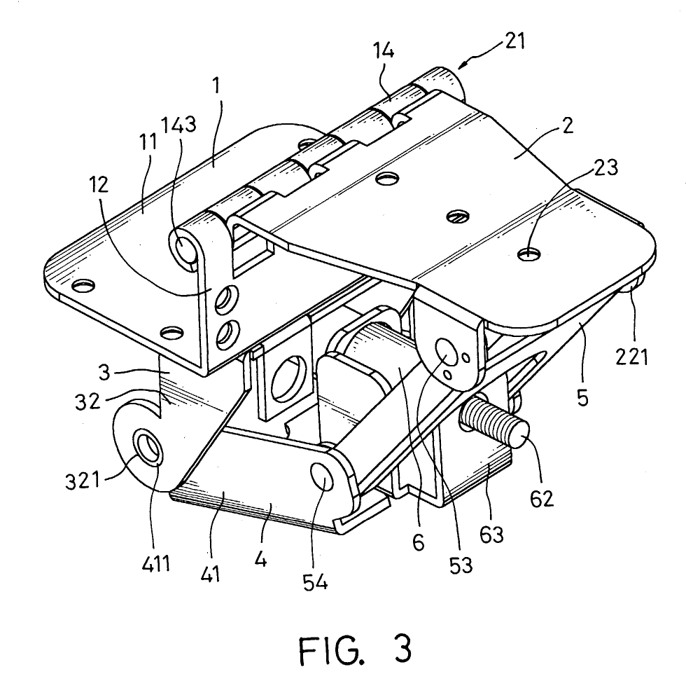

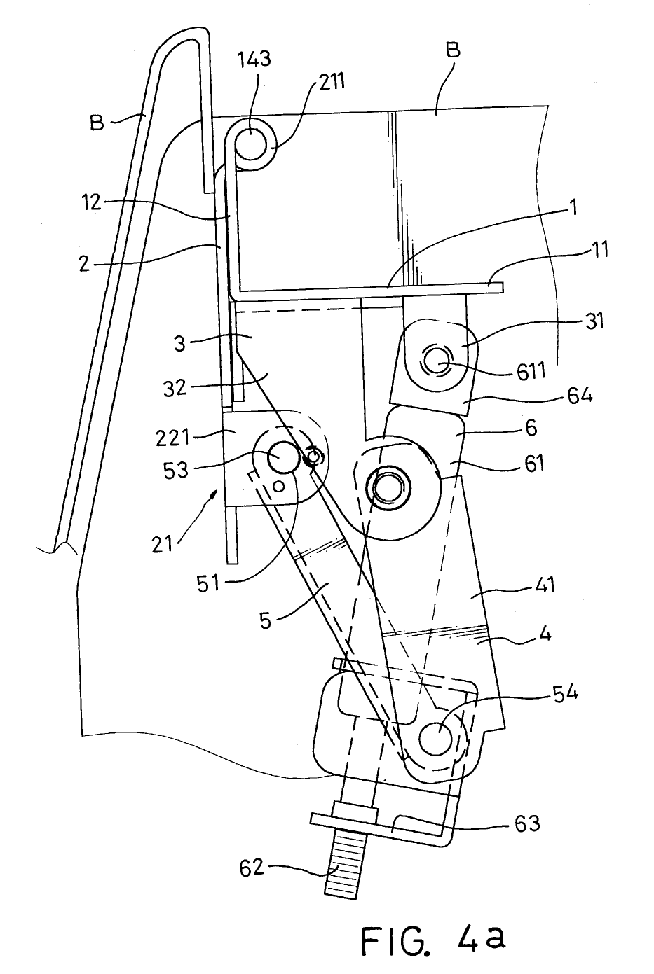

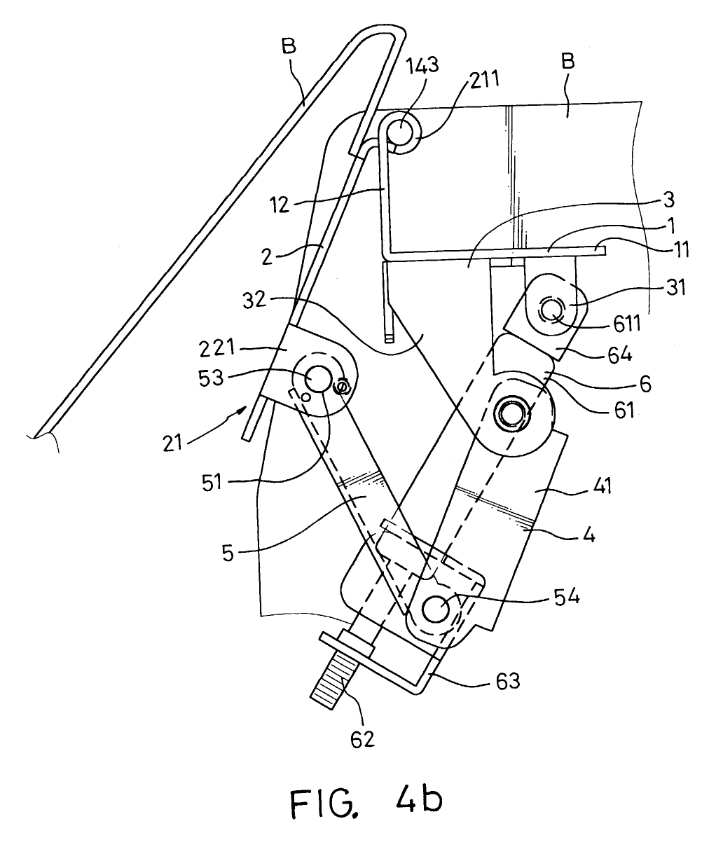

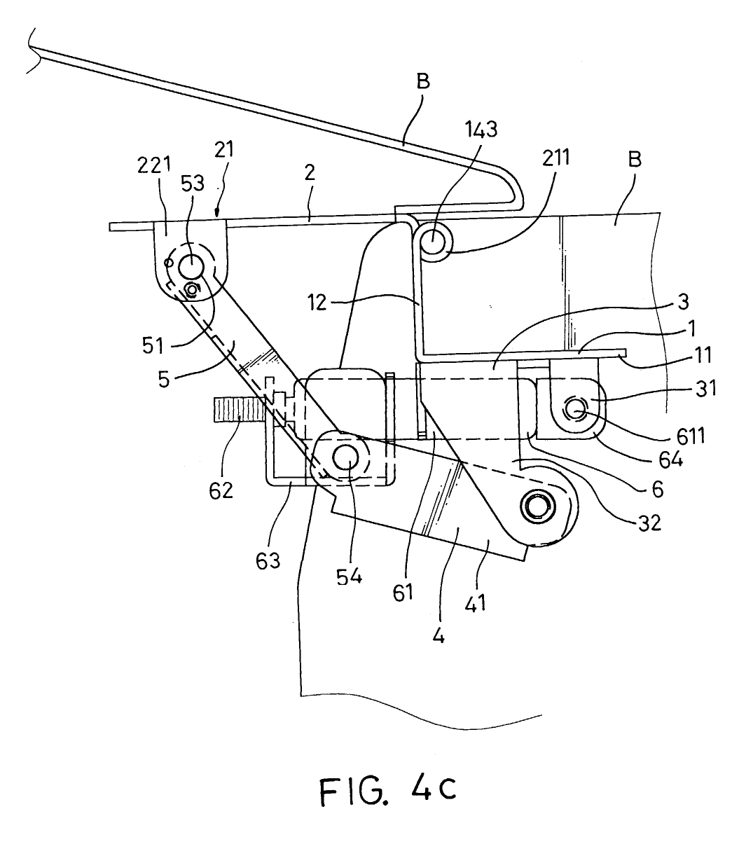

Referring FIGS. 1 and 3 again, the pivotal shaft assembly of the present invention after being assembled is shown in FIG. 3 and the pivotal shaft assembly of the present invention is mounted to a cabinet is shown in FIG. 1. Referring to FIG. 4a, in case of pulling a movable object B such as a door, the movable part 2 rotates with respect to the stationary part 1 such that the connection part 5 can actuate the relay part 4 to rotate upward gradually with respect to the axial part 3 during the connection part 5 rotating along with the movable part 2. At this time, the extension stem 52 is subjected to a foreign force from the user gradually to extend outward to the extreme length thereof, i.e., the motionless point as shown in FIG. 4b and the relay part 4 and the extension part 6 form a state of axial straight line such that the entire pivotal shaft assembly keeps in a state of standstill. If the user exerts an upward force further to allow the extension stem 62 passing over the motionless point, the extension stem 62 moves into the rod body 61 gradually and drags the relay part 4 upward so as to urge the connection part 5 moving relative to the movable part 2. In this way, the door is capable of opening gradually to reach a full open, i.e., lifting gradually.

On the contrarily, in case of the door being shut, the door is pressed downward to allow the extension stem 62 and the relay part 4 exceeds the standstill state shown in FIG. 4b. At this time, the relay part 4 rotates downward with the aid of a pull performed by the extension part 6 and the connection part 5 and the movable part 2 moves downward synchronously till the door touching the stationary object A such as till touching an open end of the cabinet so that the cabinet can be shut completely.

While the invention has been described with reference to a preferred embodiment thereof, it is to be understood that modifications or variations may be easily made without departing from the spirit of the invention, which is defined in the appended claims.

What is claimed is:

1. A pivotal shaft assembly, comprising:
a stationary part, being a frame with an upper portion and a lower portion;
a movable part, being a plate body, providing a rear end thereof axially connecting with the upper portion of the stationary part;
an joint part, being a frame with a front end and a rear end, being disposed under the stationary part and fixed to the lower portion of the stationary part and the rear end thereof being a connecting end;
a relay part, being a frame with a front end and a rear end, the rear end thereof axially connecting with the front end of the joint part;
a connection part, being a frame with a lower end and an upper end, the lower end axially connecting with relay part and the upper end thereof axially connecting with a front end of the movable part;
an extension part, being a rod body and fixed to the connecting end of the axial part, providing an extension stem at a front end thereof with a pull force, the extension stem joining with the front end of the relay part and an axial connection position of the connection part pivotally;
whereby, once the stationary part and the movable part are fixedly attached to an open end of a stationary object and an inner side of a movable object respectively, the extension stem stretches to an extreme length thereof during the relay part and the extension part being axially aligned as a line so as to form a standstill point; and if an foreign force is exerted, the extension stem is drawn inward to allow the relay part, the connection part and the movable part generating upward or downward relative motions to each other such that the movable object can open or shut the open end of the stationary object automatically.

2. The pivotal shaft assembly as defined in claim 1, wherein the extension part is an inward pulled elastic rod, a pneumatic cylinder or a hydraulic cylinder.

3. The pivotal shaft assembly as defined in claim 1, wherein the stationary part at an upper edge thereof has an axial join part and the axial join part has an annual section with at least a recess to correspond to and accommodate another annular section projecting from the rear end of the movable part so as to be passed through with a pin shaft.

4. The pivotal shaft assembly as defined in claim 1, wherein the movable part at the front end thereof extends downward two tabs with an axial hole being provided at each of the two tabs and the connection part at the front end thereof provided with a fastening hole respectively such that a shaft pin pass through the axial holes and the fastening holes.

5. The pivotal shaft assembly as defined in claim 1, wherein the connecting end is a inversed U shaped fitting piece with two opposite lateral sides thereof having a hole respectively for being inserted with an insert end at a rear end of the rod body on the extension part and a pin shaft passing through the hole and axial holes of the insert piece so as form a pivotal connection.

6. The pivotal shaft assembly as defined in claim 6, wherein the insert piece at a rear end thereof protrudes a joining end and the insert piece has a joining hole so as to be capable of engaging with each other.

7. The pivotal shaft assembly as defined in claim 6, wherein the joining end and the joining hole are provided with screw threads for being joined to each other.

8. The pivotal shaft assembly as defined in claim 1, wherein the joint part at two lateral sides thereof extends downward a side plate respectively with a side hole being provided at each of the side plates and the relay part at two wing plates thereof provides a projection ring respectively to be inserted into the side holes so as to be joined to each other.

9. The pivotal shaft assembly as defined in claim 1, wherein the relay part at two opposite wing plates has a connecting hole respectively at the front end thereof and the connecting part has projection holes corresponding to the connecting holes such that a pin shaft can pass through the connecting hole and the projection holes to pivotally connect with the stem end of the extension stem and to form a linking movement.

10. The pivotal shaft assembly as defined in claim 1, wherein the rod body and the stem end are received and fixed to a support hole at one end and a locating hole at another end of a follow and the follower at both lateral sides thereof has a piercing hole respectively such that the piercing holes in company with the connecting holes and the projection holes are passed through with a shaft pin to constitute pivotal connection.

11. The pivotal shaft assembly as defined in claim 10, wherein the stem end and the locating hole are provided with screw threads for being joined to each other by way of screw fastening.
